(19) United States
(12) Patent Application Publication
(10) Pub. No.: US 2025/0066039 A1
(43) Pub. Date: Feb. 27, 2025

(54) SEAL APPLICATION METHOD

(71) Applicant: MITSUBISHI HEAVY INDUSTRIES, LTD., Tokyo (JP)

(72) Inventors: Akira IKADA, Tokyo (JP); Tomohiro MURAI, Tokyo (JP)

(21) Appl. No.: 18/769,402

(22) Filed: Jul. 11, 2024

(30) Foreign Application Priority Data
Aug. 23, 2023 (JP) 2023-135698

(51) Int. Cl. B64F 5/40; B29C 73/12; B29C 73/26; B64C 3/26

(52) U.S. Cl. CPC B64F 5/40; B29C 73/12; B64C 3/26; B29C 2073/262

(57) ABSTRACT

A seal application method of applying a sealing material in a narrow portion serving as a hollow portion being formed inside a target object and communicating with outside, the seal application method including: arranging the target object such that a target surface inside the narrow portion faces downward; forming a brush coat by inserting into the narrow portion a brush coating device including at an upper portion thereof a brush portion with the sealing material adhered thereto, pressing the brush portion upward and rubbing the brush portion against the target surface, thereby applying the sealing material to the target surface; after forming the brush coat, inverting the target object such that the target surface faces upward; and, after inverting the target object, forming an edge seal being thicker than the brush coat by inserting an edge sealing device into the narrow portion and causing the edge sealing device to apply the sealing material onto the brush coat from above.

### CROSS-REFERENCE TO RELATED APPLICATIONS

This application claims the benefit of priority to Japanese Patent Application Number 2023-135698 filed on Aug. 23, 2023. The entire contents of the above-identified application are hereby incorporated by reference.

### TECHNICAL FIELD

The present disclosure relates to a seal application method.

### RELATED ART

JP 2020-104443 A discloses a structure of a wing of an aircraft. The wing includes a skin and a stringer. The skin and the stringer are laid on top of each other. The stringer includes a connection portion connected to the skin and a projection separated from the skin. A hollow portion is formed between the projection and the skin.

### SUMMARY

Here, a defect may occur at the hollow portion between the skin and the stringer. In that case, since the location where the defect occurs is very narrow, it is difficult to perform seal repairing with high accuracy.

The present disclosure has been made to solve the above problem, and an object of the present disclosure is to provide a seal application method by which seal repairing can be performed with high accuracy.

To solve the above problem, a seal application method according to an embodiment of the present disclosure is a seal application method of applying a sealing material in a narrow portion serving as a hollow portion being formed inside a target object and communicating with outside, and includes: arranging the target object such that a target surface inside the narrow portion faces downward; forming brush coat by inserting into the narrow portion a brush coating device including, at an upper portion thereof, a brush portion with a sealing material adhered thereto, pressing the brush portion upward and rubbing the brush portion against the target surface, thereby applying the sealing material to the target surface; after forming the brush coat, inverting the target object such that the target surface faces upward; and, after inverting the target object, forming an edge seal being thicker than the brush coat by inserting an edge sealing device into the narrow portion and causing the edge sealing device to apply the sealing material onto the brush coat from above.

According to the seal application method of the present disclosure, seal repairing can be performed with high accuracy.

### BRIEF DESCRIPTION OF DRAWINGS

The disclosure will be described with reference to the accompanying drawings, wherein like numbers reference like elements.

FIG. 1 is a perspective view illustrating a target object according to an embodiment of the present disclosure.

FIG. 2 is a diagram illustrating a schematic configuration of a cleaning device and a step of cleaning a target surface according to the embodiment of the present disclosure.

FIG. 3 is a diagram illustrating a schematic configuration of a sanding device and a step of sanding the target surface according to the embodiment of the present disclosure.

FIG. 4 is a diagram illustrating a schematic configuration of a brush coating device and a step of forming a brush coat on the target surface according to the embodiment of the present disclosure.

FIG. 5 is a diagram illustrating a schematic configuration of an edge sealing device and a step of forming an edge seal on a surface of the brush coat according to the embodiment of the present disclosure.

FIG. 6 is a diagram illustrating a schematic configuration of an inspection device and a step of inspecting a seal according to the embodiment of the present disclosure.

FIG. 7 is a flowchart illustrating a procedure of a seal application method according to the embodiment of the present disclosure.

FIG. 8 is a diagram illustrating an initial arrangement of the target object according to the embodiment of the present disclosure.

FIG. 9 is a diagram illustrating a step of inverting the target object according to the embodiment of the present disclosure.

### DESCRIPTION OF EMBODIMENTS

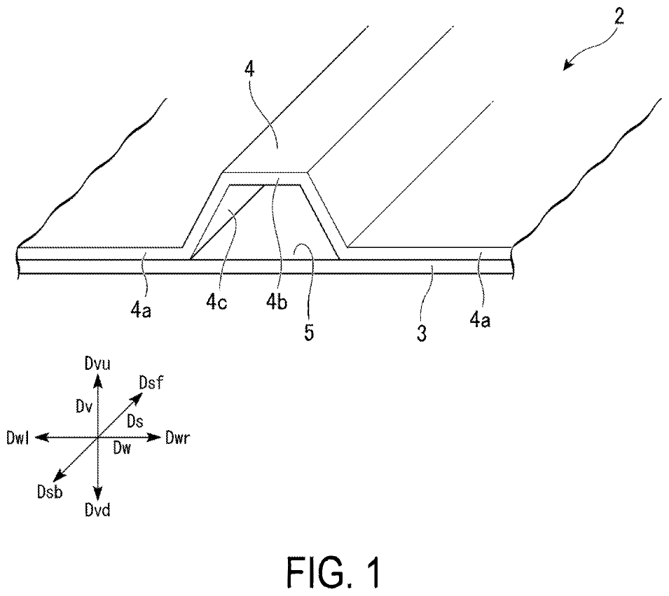

Hereinafter, a seal application method according to an embodiment of the present disclosure will be described with reference to FIGS. 1 to 9.

The seal application method of the present embodiment is used for repairing a wing of an aircraft, for example. Hereinafter, the wing to be repaired is referred to as a target object 2. As illustrated in FIG. 1, the target object 2 includes a skin 3 and a stringer 4.

The skin 3 constitutes an outer shell of the wing of the aircraft. The skin 3 is formed in a flat plate shape, for example. The stringer 4 is attached to the skin 3. The stringer 4 includes a connection portion 4a connected to the skin 3 and a projection 4b separated from the skin 3. The connection portion 4a is located on a side closer to the skin 3 with respect to the projection 4b. The projection 4b is located on a side away from the skin 3 with respect to the connection portion 4a.

A hollow portion (hereinafter referred to as a narrow portion 4c) is formed between the projection 4b and the skin 3. The narrow portion 4c is formed to extend in one direction. The stringer 4 is, for example, a hat stringer having a hat shape. The skin 3 and the stringer 4 are made of a composite material such as glass fiber reinforced plastics (GFRP) or carbon fiber reinforced plastics (CFRP).

Here, the target object 2 is arranged so as to extend in the horizontal direction. That is, the narrow portion 4c extends in one direction along a horizontal plane.

Hereinafter, the extending direction of the narrow portion 4c is referred to as a front-back direction Ds, and the front side is denoted by the reference sign “Dsf” and the back side is denoted by the reference sign “Dsb”. In the horizontal direction, one direction orthogonal to the front-back direction Ds is referred to as a “left-right direction Dw”, and the left side is denoted by the reference sign “Dwl” and the right side is denoted by the reference sign “Dwr”. A direction orthogonal to the front-back direction Ds and the left-right direction Dw is referred to as an “up-down direction Dv”, and the upper side is denoted by the reference sign “Dvu” and the lower side is denoted by the reference sign “Dvd”.

When a defect occurs in the narrow portion 4c, the defect is repaired by applying a sealing material to the defect. A surface of the narrow portion 4c to be repaired by applying the sealing material is referred to as a target surface 5. Hereinafter, the seal application method of the present embodiment will be described by taking as an example a case in which a defect occurs at a surface of the skin 3 of the narrow portion 4c and the surface of the skin 3 where the defect occurs is the target surface 5 on which seal repairing is to be performed.

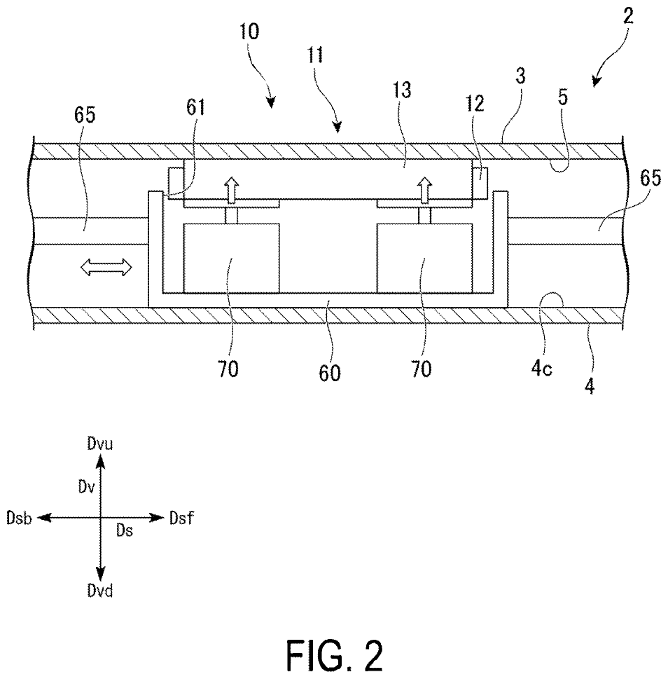

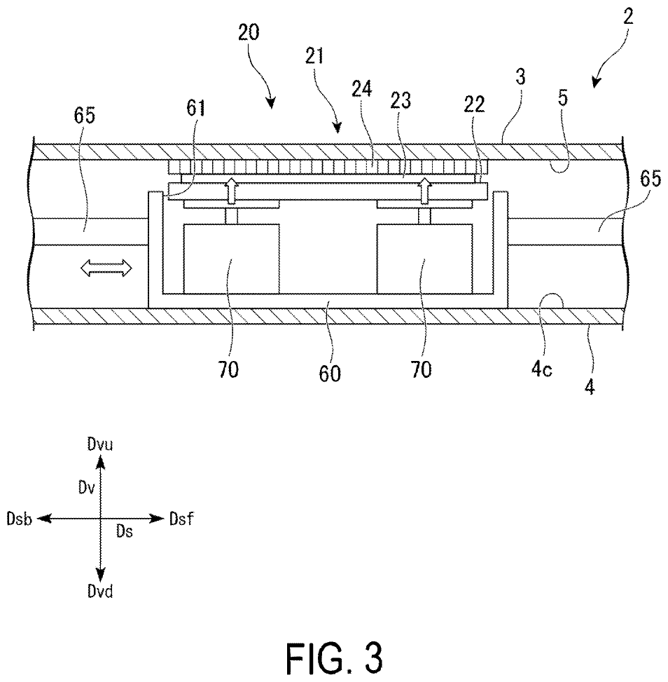

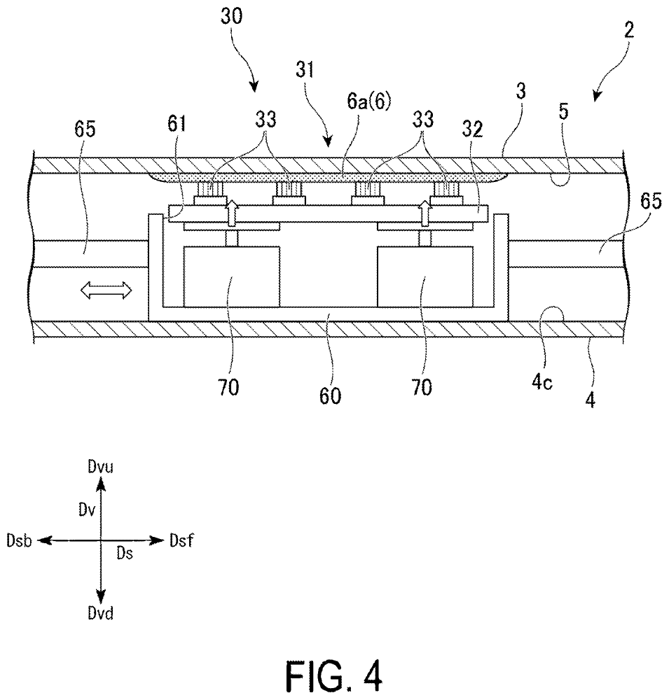

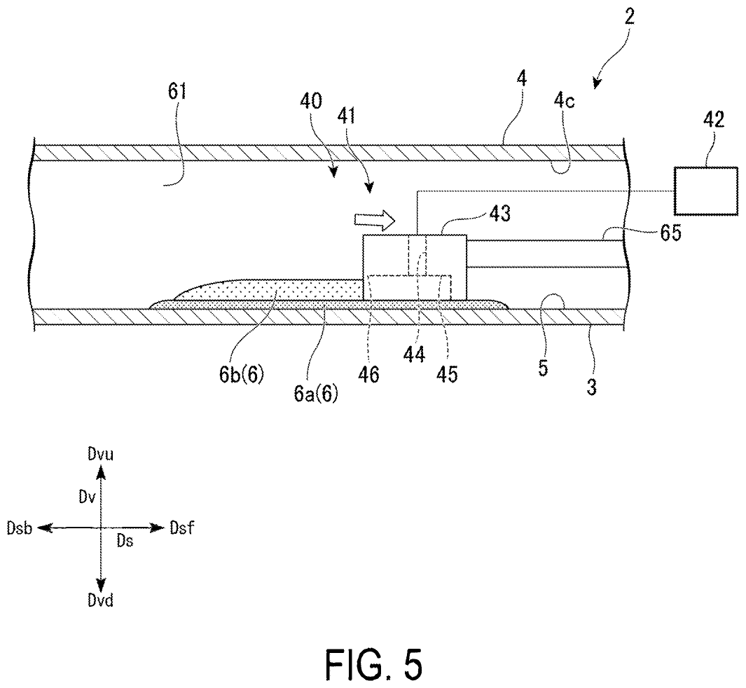

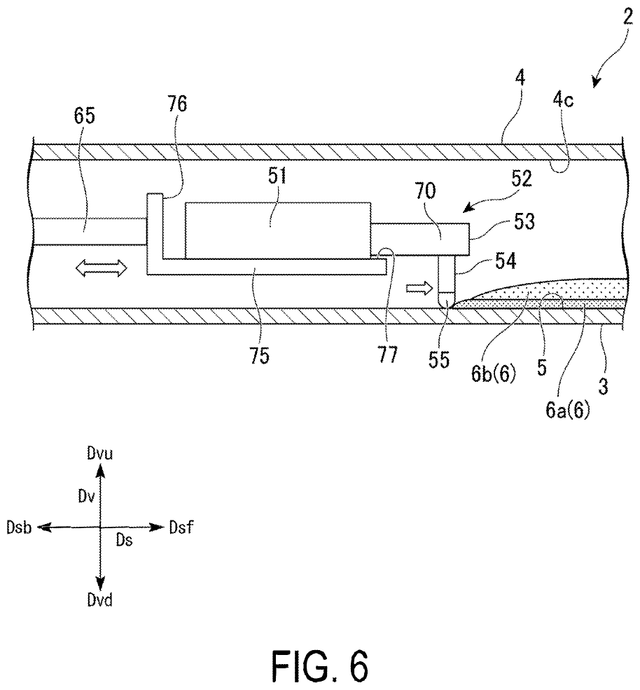

In the seal application method, for example, a brush coating device 30 illustrated in FIG. 4, an edge sealing device 40 illustrated in FIG. 5, and an inspection device 50 illustrated in FIG. 6 are used in addition to a cleaning device 10 illustrated in FIG. 2 and a sanding device 20 illustrated in FIG. 3.

### Cleaning Device

As illustrated in FIG. 2, the cleaning device 10 is used in a state of being inserted into the narrow portion 4c. The cleaning device 10 includes a casing 60, a pressing portion 70, and a cleaning portion 11.

### Casing

The casing 60 extends in the front-back direction Ds. The casing 60 is formed in a box shape having an opening 61 that opens upward.

A pipe 65 is attached to either end portion of the casing 60 in the front-back direction Ds. The pipe 65 extends from the casing 60 in the front-back direction Ds. For example, an operator can move the cleaning device 10 in the front-back direction Ds by moving the pipe 65 in the front-back direction Ds. The pipe 65 may be provided not only at both end portions of the casing 60 in the front-back direction Ds but also at one of the front end and the back end of the casing 60. Alternatively, a wire extending in the front-back direction Ds may be provided in place of the pipe 65. The method of moving the cleaning device 10 is not limited to manual movement. For example, the pipe 65 may be held by a robot and the cleaning device 10 may be automatically moved in the front-back direction Ds.

### Pressing Portion

A plurality of (two in the illustrated example) pressing portions 70 are accommodated in the casing 60. The number of the pressing portions 70 can be changed as appropriate. Only one pressing portion 70 may be provided in the casing 60, or three or more pressing portions 70 may be provided in the casing 60. Each of the pressing portions 70 generates a pressing force upward against the target surface 5 to which each of the pressing portions 70 faces. Examples of the pressing portion 70 include an air cylinder and an oil cylinder. In addition, the pressing portion 70 may be a rubber bag, an air bag, a rubber balloon, or the like that expands and contracts depending on the amount of air inside.

### Cleaning Portion

The cleaning portion 11 is provided at an upper portion of the cleaning device 10 and slightly protrudes upward from the opening 61 of the casing 60. The cleaning portion 11 includes a base portion 12 and a waste cloth 13.

The base portion 12 is placed on the plurality of pressing portions 70. The base portion 12 extends in the front-back direction Ds.

The waste cloth 13 is wound around a central portion of the base portion 12 in the front-back direction Ds. The waste cloth 13 covers the upper surface of the base portion 12.

By reciprocating the cleaning device 10 in the front-back direction Ds in a state in which the waste cloth 13 with a solvent adhered thereto is pressed against the target surface 5, the target surface 5 can be cleaned while a pressing force is uniformly applied to the target surface 5.

### Sanding Device

As illustrated in FIG. 3, the sanding device 20 is used in a state of being inserted into the narrow portion 4c as in the case of the cleaning device 10. The sanding device 20 includes the casing 60, the pressing portions 70, and a sanding portion 21. The sanding device 20 is a device in which the sanding portion 21 is provided at the upper portion in place of the cleaning portion 11 of the cleaning device 10.

### Sanding Portion

The sanding portion 21 includes a base portion 22, a bonding portion 23, and a scotch 24.

The base portion 22 is placed on the plurality of pressing portions 70. The base portion 22 extends in the front-back direction Ds.

The bonding portion 23 is provided at the upper surface of the base portion 22. The scotch 24 is placed on the bonding portion 23. The bonding portion 23 bonds the scotch 24 to the base portion 22.

The scotch 24 slightly protrudes upward from the opening 61 of the casing 60. The scotch 24 is formed in a sponge shape.

By reciprocating the sanding device 20 in the front-back direction Ds in a state in which the scotch 24 is pressed against the target surface 5, the target surface 5 can be polished and smoothened while a pressing force is uniformly applied to the target surface 5.

Brush Coating Device As illustrated in FIG. 4, the brush coating device 30 is used in a state of being inserted into the narrow portion 4c as in the case of the cleaning device 10. The brush coating device 30 includes the casing 60, the pressing portions 70, and a brush portion 31. The brush coating device 30 is a device in which the brush portion 31 is provided at the upper portion in place of the cleaning portion 11 of the cleaning device 10.

### Brush Portion

The brush portion 31 includes a base portion 32 and a brush 33.

The base portion 32 is placed on the plurality of pressing portions 70. The base portion 32 extends in the front-back direction Ds.

### Brush

A plurality of brushes 33 is attached to the base portion 32. Each of the brushes 33 slightly protrudes upward from the opening 61 of the casing 60. The plurality of brushes 33 is arranged at regular intervals in the front-back direction Ds. Each of the brushes 33 extends toward the target surface 5 and applies the sealing material to the target surface 5.

By reciprocating the brush coating device 30 in the front-back direction Ds in a state in which the brushes 33 with the sealing material adhered thereto is pressed against the target surface 5 at which a defect to be repaired occurs, the sealing material can be applied to the target surface 5 while a pressing force is uniformly applied to the target surface 5. Accordingly, the sealing material is applied to the target surface 5 with a uniform thickness. By curing the sealing material applied to the target surface 5 in this way, a brush coat 6a having a uniform thickness is formed on the target surface 5.

### Edge Sealing Device

As illustrated in FIG. 5, the edge sealing device 40 is used in a state of being inserted into the narrow portion 4c as in the case of the cleaning device 10.

The edge sealing device 40 includes a forming nozzle 41 and a supply portion 42.

### Forming Nozzle

The forming nozzle 41 includes a nozzle main body 43 and a supply hole 44.

The nozzle main body 43 is placed on the target surface 5 (on the brush coat 6a in the illustrated example). A cavity 45 that opens downward is formed in the nozzle main body 43. The sealing material is supplied to the cavity 45 from the supply portion 42 to be described below. The cavity 45 is formed with an opening 46 that opens backward.

The nozzle main body 43 is provided with the pipe 65 as in the case of the cleaning device 10. The pipe 65 extends forward from the nozzle main body 43. For example, an operator can move the forming nozzle 41 in the front-back direction Ds by moving the pipe 65 in the front-back direction Ds. Alternatively, a wire extending in the front-back direction Ds may be provided in place of the pipe 65. The method of moving the forming nozzle 41 is not limited to manual movement. For example, the pipe 65 may be held by a robot and the forming nozzle 41 may be automatically moved in the front-back direction Ds. Alternatively, the nozzle main body 43 may be provided with wheels that roll on the target surface 5 (or on the brush coat 6a) so that the forming nozzle 41 is moved in the front-back direction Ds by the rolling of the wheels.

The supply hole 44 is formed in an upper portion of the nozzle main body 43. The supply hole 44 extends in the up-down direction Dv and communicates with the cavity 45 on the lower side Dvd. The supply hole 44 guides the sealing material guided from the supply portion 42 into the cavity 45.

The supply portion 42 supplies the sealing material for forming an edge seal 6b to the forming nozzle 41. The supply portion 42 may be inserted into the narrow portion 4c together with the forming nozzle 41, or may be arranged outside the narrow portion 4c.

The forming nozzle 41 is placed such that the cavity 45 covers a location (a location overlapping a defect to be repaired in the up-down direction Dv) at which the edge seal 6b is desired to be formed on the target surface 5 from above. In this state, the sealing material is supplied from the supply portion 42, and the sealing material is cured to form the edge seal 6b.

Hereinafter, the brush coat 6a and the edge seal 6b formed on the target surface 5 may be collectively referred to as a seal 6.

### Inspection Device

As illustrated in FIG. 6, the inspection device 50 is used in a state of being inserted into the narrow portion 4c as in the case of the cleaning device 10. The inspection device 50 includes a casing 75, a telescopic mechanism 51, and an inspection portion 52.

### Casing

The casing 75 extends in the front-back direction Ds. The casing 75 is formed in a box shape having an opening 76 that opens upward. The casing 75 is formed with a lead-out hole 77 machined at the front.

At the back end of the casing 75, the pipe 65 is provided as in the case of the cleaning device 10. The pipe 65 extends from the casing 75 in the front-back direction Ds. For example, an operator can move the inspection device 50 in the front-back direction Ds by moving the pipe 65 in the front-back direction Ds. The pipe 65 may be provided not only at both end portions of the casing 75 in the front-back direction Ds but also at one of the front end and the back end of the casing 75. Alternatively, a wire extending in the front-back direction Ds may be provided in place of the pipe 65. The method of moving the inspection device 50 is not limited to manual movement. For example, the pipe 65 may be held by a robot and the inspection device 50 may be automatically moved in the front-back direction Ds.

### Telescopic Mechanism

The telescopic mechanism 51 is accommodated in the casing 75. The telescopic mechanism 51 expands and contracts in the front-back direction to move a base portion 53 of the inspection portion 52 to be described below in the front-back direction Ds.

### Inspection Portion

The inspection portion 52 is arranged at the front of the telescopic mechanism 51. The inspection portion 52 includes the base portion 53, an arm 54, and a contact portion 55.

The base portion 53 is provided so as to be pulled out from the inside to the outside of the casing 75 through the lead-out hole 77. The base portion 53 extends forward from the telescopic mechanism 51.

The arm 54 is provided at a front end portion of the base portion 53. The arm 54 extends downward toward the target surface 5.

The contact portion 55 is provided at a lower end of the arm 54. The contact portion 55 comes into contact with the seal 6 on the target surface 5 from the back. The contact portion 55 is formed of an elastic material such as rubber, for example. The contact portion 55 protrudes downward. A lower end of the contact portion 55 is formed in a spherical shape. The inspection device 50 inspects the adhesion of the seal 6 by pressing the contact portion 55 against the seal 6 from the back side Dsb toward the front side Dsf.

### Procedure of Seal Application Method

By using the above-described various devices, the sealing material is applied to repair a defect generated in the narrow portion 4c serving as a hollow portion which is formed inside the target object 2 and communicates with the outside.

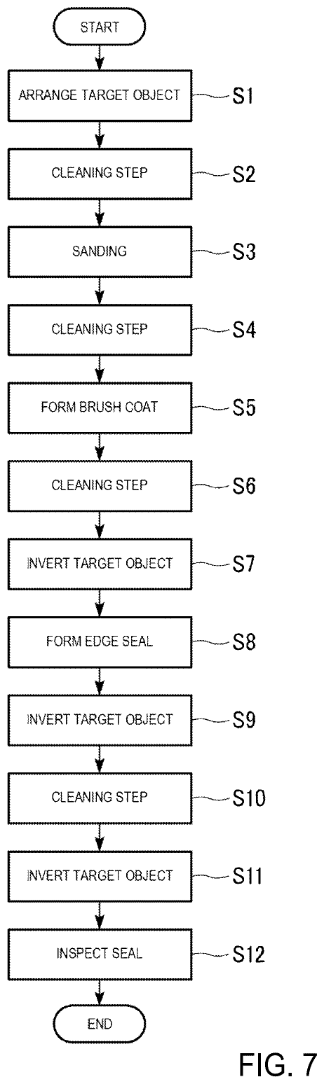

Hereinafter, a procedure of the seal application method according to the present embodiment will be described with reference to the flowchart of FIG. 7.

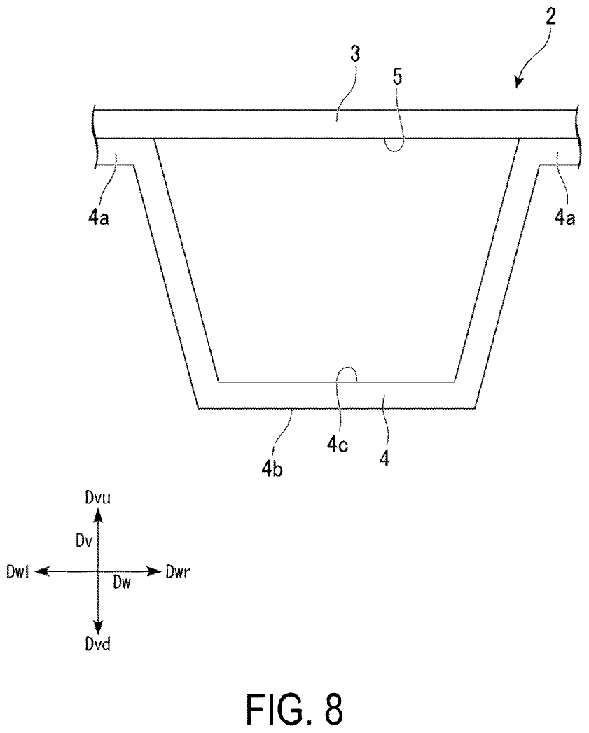

First, as illustrated in FIG. 8, the target object 2 is arranged such that the target surface 5 in the narrow portion 4c faces downward (step S1). In step S1, the target object 2 is arranged to extend in the horizontal direction such that the skin 3 is located above the stringer 4. After step S1, a cleaning step is performed as preliminary cleaning before sanding to be described below (step S2). In step S2, the cleaning device 10 is inserted into the narrow portion 4c while sliding the lower surface of the casing 60 to clean the target surface 5. At this time, a solvent is adhered to the waste cloth 13. While the waste cloth 13 with the solvent adhered thereto is pressed upward by the pressing portions 70, the cleaning device 10 is reciprocated in the front-back direction Ds to rub the waste cloth 13 on the target surface 5. In this way, the target surface 5 is cleaned.

After step S2, the sanding is performed (step S3). In step S3, the sanding device 20 is inserted into the narrow portion 4c while sliding the lower surface of the casing 60 to perform the sanding of the target surface 5. While the scotch 24 is pressed upward by the pressing portions 70, the sanding device 20 is reciprocated in the front-back direction Ds to rub the sanding device 20 on the target surface 5. In this way, the sanding of the target surface 5 is performed. By this step, the target surface 5 is activated.

After step S3, in order to remove powder or the like generated by the sanding, the cleaning step is performed again as final cleaning before forming the brush coat 6a (step S4). In step S4, the cleaning device 10 is inserted into the narrow portion 4c to clean the target surface 5 in the same manner as in step S2.

Then, the brush coating device 30 is inserted into the narrow portion 4c while sliding the lower surface of the casing 60 to apply the sealing material to the target surface 5, thereby forming the brush coat 6a (step S5). At this time, the sealing material is adhered to the brushes 33. While the brushes 33 with the sealing material adhered thereto is pressed upward by the pressing portions 70 against the target surface 5 at which the defect is generated, the brush coating device 30 is reciprocated in the front-back direction Ds to rub the brushes 33 on the target surface 5. In this way, the sealing material is applied to the target surface 5 with a uniform thickness. The sealing material is cured to form the brush coat 6a on the target surface 5.

After step S5, the cleaning step is performed again (step S6). In step S6, the cleaning device 10 is inserted into the narrow portion 4c to clean the surface of the target surface 5 in the same manner as in steps S2 and S4. In step S6, for a portion of the surface of the target surface 5 at which the brush coat 6a is formed, the cleaning portion 11 is pressed and rubbed against the target surface 5 from above the brush coat 6a to clean the surface of the target surface and the surface of the brush coat 6a.

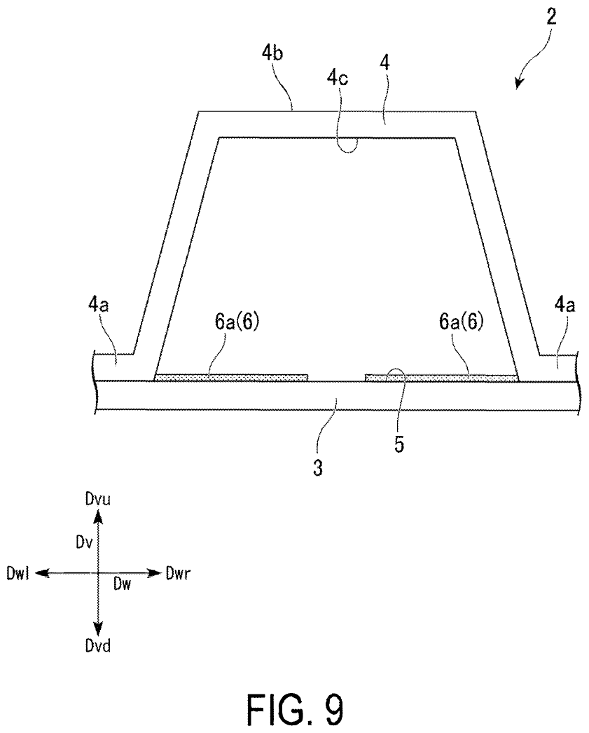

After step S6, as illustrated in FIG. 9, the target object 2 is inverted such that the target surface 5 faces upward (step S7). In step S7, the target object 2 is arranged to extend in the horizontal direction such that the skin 3 is located below the stringer 4.

Then, the edge sealing device 40 is inserted into the narrow portion 4c to apply the sealing material on the brush coat 6a from above, thereby forming the edge seal 6b which is thicker than the brush coat 6a (step S8). In step S8, the forming nozzle 41 is placed on the brush coat 6a, and the sealing material is supplied into the cavity 45. At this time, the forming nozzle 41 needs to be placed such that the cavity 45 covers the defect from above. When the forming nozzle 41 is left to stand in this state, the sealing material is cured on the brush coat 6a so as to follow the shape of the cavity 45. The sealing material supplied at this time is viscous, and the sealing material is leveled on the brush coat 6a under the influence of the weight thereof in the process of curing. By gradually moving the forming nozzle 41 forward, the sealing material is applied so as to extend in the front-back direction Ds. The sealing material applied on the brush coat 6a is cured to form the edge seal 6b.

After step S8, the target object 2 is inverted such that the target surface faces downward (step S9). In step S9, the target object 2 is arranged to extend in the horizontal direction such that the skin 3 is located above the stringer 4.

After step S9, the cleaning step is performed again (step S10). In step S10, the cleaning device 10 is inserted into the narrow portion 4c to clean the surface of the target surface 5 in the same manner as in steps S2, S4, and S6. In step S10, for a portion of the surface of the target surface 5 at which the seal 6 including the brush coat 6a and the edge seal 6b is formed, the cleaning portion 11 is pressed and rubbed against the target surface 5 from above the seal 6 to clean the surface of the target surface 5 and the surface of the seal 6.

After step S10, the target object 2 is inverted such that the target surface faces upward (step S11). In step S11, the target object 2 is arranged to extend in the horizontal direction such that the skin 3 is located below the stringer 4.

After step S11, inspection of the seal 6 is performed (step S12). In step S12, the inspection device 50 is inserted into the narrow portion 4c, and the contact portion 55 is pressed and rubbed against the seal 6 formed in the narrow portion 4c from a direction intersecting the up-down direction Dv, thereby inspecting the adhesion of the seal. In the illustrated example, the telescopic mechanism 51 expands to push the base portion 53 forward and press the contact portion 55 against the brush coat 6a. At this time, the contact portion 55 is pressed so as to be rubbed against the brush coat 6a in the vicinity of a boundary portion between the brush coat 6a and the target surface 5. When the brush coat 6a is not peeled off, it can be determined that the adhesion of the brush coat 6a is sufficiently ensured.

In step S12, the contact portion 55 may be pressed against the edge seal 6b. At this time, the contact portion 55 is pressed so as to be rubbed against the edge seal 6b in the vicinity of a boundary portion between the edge seal 6b and the brush coat 6a. When the edge seal 6b is not peeled off, it can be determined that the adhesion of the edge seal 6b is sufficiently ensured.

In step S12, a camera may be provided at the inspection device 50 so that the appearance and the dimensions of the seal 6 can be inspected with the naked eye.

Through the above procedure, the application of the sealing material into the narrow portion 4c is completed. In this way, even when the narrow portion 4c is long in the front-back direction Ds and thus it is difficult to manually apply the sealing material, the sealing material can be remotely applied on the defect. Note that, instead of performing all the cleaning steps (steps S2, S4, S6, and S10), they may be omitted as appropriate. In addition, when the cleaning step in step S10 is omitted, steps S9 and S11 of inverting the target object 2 are also omitted.

### Operational Effects

The seal application method of the present embodiment can exert the following effects.

The seal application method of the present embodiment is a seal application method of applying the sealing material in the narrow portion 4c serving as a hollow portion which is formed inside the target object 2 and communicates with the outside. The seal application method includes: step S1 of arranging the target object 2 such that the target surface 5 inside the narrow portion 4c faces downward; step S5 of forming the brush coat 6a by inserting into the narrow portion 4c the brush coating device 30 including, at an upper portion thereof, the brush portion 31 with the sealing material adhered thereto, pressing the brush portion 31 upward and rubbing the brush portion 31 against the target surface 5, thereby applying the sealing material to the target surface 5; step S7 of, after forming the brush coat 6a, inverting the target object 2 such that the target surface 5 faces upward; and step S8 of, after inverting the target object 2, forming the edge seal 6b being thicker than the brush coat 6a by inserting the edge sealing device 40 into the narrow portion 4c and causing the edge sealing device 40 to apply the sealing material onto the brush coat 6a from above.

Accordingly, in forming the brush coat 6a, the sealing material for the brush coat 6a can be applied to the target surface 5 by pressing the brush portion 31 of the brush coating device 30 from below against the target surface facing downward. Thus, since the pressing force of the brush coating device against the target surface 5 can be adjusted without taking into account the gravity of the brush coating device 30, the brush coat 6a can be uniformly formed on the target surface 5. In addition, the sealing material can be prevented from dripping and adhering to portions other than a portion requiring seal repairing on the target surface 5. Further, in forming the edge seal 6b, the sealing material for the edge seal 6b can be applied to the surface of the brush coat 6a facing upward. Since the edge seal 6b is thicker than the brush coat 6a, it takes time to cure the edge seal 6b. Accordingly, the sealing material for the edge seal 6b is leveled by the gravity before the sealing material is cured, and thus the edge seal 6b can be formed so as to closely adhere to the surface of the brush coat 6a.

Thus, since the brush coat 6a and the edge seal 6b can be easily formed so as to closely adhere to a defect generated at the target surface 5, seal repairing can be performed with high accuracy.

The seal application method of the present embodiment includes step S3 of sanding the target surface 5 by inserting the sanding device 20 into the narrow portion 4c and pressing the sanding device 20 upward and rubbing the sanding device 20 against the target surface 5, after arranging the target object 2 such that the target surface 5 faces downward and before forming the brush coat 6a.

For example, if the target object 2 is arranged such that the target surface 5 faces upward, the sanding device 20 needs to be inserted upper side down. This may cause the sanding device to come into contact with a portion of the target surface 5 where no sanding is required due to the gravity. On the other hand, according to the present embodiment, since the sanding device can be pressed against the target surface 5 from below, the sanding device can be prevented from coming into contact with a portion of the target surface 5 where no sanding is required due to the influence of the gravity. Accordingly, it is possible to perform sanding on only a portion of the target surface 5 requiring the sanding by pressing the sanding device against only the portion requiring the sanding. In addition, it is possible to prevent ground powder from falling onto and contaminating the surface of the stringer 4 located below the target surface 5 before the sanding device returns to the opening of the narrow portion 4c after the sanding.

Since the brush coat 6a can be formed after the target surface 5 is activated by the sanding of the target surface 5 in this way, the adhesion of the brush coat 6a to the target surface 5 can be improved.

The seal application method of the present embodiment may include steps S2, S4, S6, and S10 of cleaning the target surface 5 by inserting the cleaning device 10, which includes at the upper portion thereof the cleaning portion 11 with a solvent adhered thereto, into the narrow portion 4c and pressing the cleaning portion 11 upward and rubbing the cleaning portion 11 against the target surface 5, after arranging the target object 2 such that the target surface 5 faces downward and before or after step S3 of performing the sanding.

For example, if the target object 2 is arranged such that the target surface 5 faces upward, the cleaning device 10 needs to be inserted such that the cleaning portion 11 faces downward. This may cause the cleaning portion 11 to come into contact with a portion of the target surface 5 where no cleaning is required due to the gravity. On the other hand, according to the present embodiment, since the cleaning portion 11 can be pressed against the target surface 5 from below, the cleaning portion 11 can be prevented from coming into contact with a portion of the target surface 5 where no cleaning is required due to the influence of the gravity. Accordingly, it is possible to perform cleaning on only a portion of the target surface 5 requiring the cleaning by pressing the cleaning portion 11 against only the portion requiring the cleaning. Accordingly, the sanding can be performed after the cleaning of the target surface 5, and thus the accuracy of the sanding can be improved. In addition, since the target surface 5 can be cleaned after the sanding, the next step (step S5 of forming the brush coat 6a and the like) can be accurately performed.

Further, the seal application method of the present embodiment includes steps S2, S4, S6, and S10 of cleaning the target surface 5 by inserting the cleaning device 10, which includes at the upper portion thereof the cleaning portion 11 a solvent adhered thereto, into the narrow portion 4c and pressing the cleaning portion 11 upward and rubbing the cleaning portion 11 against the target surface 5, after arranging the target object 2 such that the target surface 5 faces downward and before or after step S5 of forming the brush coat 6a.

Accordingly, the brush coat 6a can be formed after cleaning the target surface 5, and thus the adhesion of the brush coat 6a to the target surface 5 can be improved. In addition, since the target surface 5 can be cleaned after forming the brush coat 6a, the next step (step S8 of forming the edge seal 6b and the like) can be accurately performed.

The seal application method of the present embodiment includes, after forming the edge seal 6b, step S12 of inspecting the adhesion of the seal 6 including the brush coat 6a and the edge seal 6b formed in the narrow portion 4c by inserting the inspection device 50, which includes the contact portion 55 protruding downward, into the narrow portion 4c and pressing and rubbing the contact portion 55 against the seal 6 from a direction intersecting the up-down direction Dv.

Accordingly, the adhesion of the seal 6 can be inspected. Thus, the accuracy of seal repairing can be improved.

### OTHER EMBODIMENTS

An embodiment according to the present disclosure has been described in detail with reference to the drawings. However, the specific configuration of the present disclosure is not limited to this embodiment. Design change without departing from the main gist of the present disclosure or the like is also included.

In the above-described embodiment, a wing including the skin 3 and the stringer 4 has been described as an example of the target object 2, but the target object 2 is not limited thereto. The target object 2 may be, for example, a pipe. When the target object 2 is a pipe, the flow path inside the pipe is the narrow portion 4c, and a part of the surface of the flow path is the target surface 5.

### Supplementary Notes

The seal application method according to each of the embodiments above is understood as follows, for example.

(1) A seal application method according to a first aspect is a seal application method of applying a sealing material in a narrow portion 4c serving as a hollow portion being formed inside a target object 2 and communicating with outside, and includes: step S1 of arranging the target object 2 such that a target surface 5 inside the narrow portion 4c faces downward; step S5 of forming a brush coat 6a by inserting into the narrow portion 4c a brush coating device 30 including at an upper portion thereof a brush portion 31 with the sealing material adhered thereto, pressing the brush portion 31 upward and rubbing the brush portion 31 against the target surface 5, thereby applying the sealing material to the target surface 5; step S7 of, after forming the brush coat 6a, inverting the target object 2 such that the target surface 5 faces upward; and step S8 of, after inverting the target object 2, forming an edge seal 6b being thicker than the brush coat 6a by inserting an edge sealing device 40 into the narrow portion 4c and causing the edge sealing device 40 to apply the sealing material onto the brush coat 6a from above.

Accordingly, in forming the brush coat 6a, the sealing material for the brush coat 6a can be applied to the target surface 5 by pressing the brush portion 31 of the brush coating device 30 from below against the target surface facing downward. Thus, since the pressing force of the brush coating device against the target surface 5 can be adjusted without taking into account the gravity of the brush coating device 30, the brush coat 6a can be uniformly formed on the target surface 5. Further, in forming the edge seal 6b, the sealing material for the edge seal 6b can be applied to the surface of the brush coat 6a facing upward. Since the edge seal 6b is thicker than the brush coat 6a, it takes time to cure the edge seal 6b. Accordingly, the sealing material for the edge seal 6b is leveled by the gravity before the sealing material is cured, and thus the edge seal 6b can be formed so as to closely adhere to the surface of the brush coat 6a.

(2) A seal application method according to a second aspect is the seal application method of (1), and may include step S3 of sanding the target surface 5 by inserting a sanding device 20 into the narrow portion 4c and pressing the sanding device 20 upward and rubbing the sanding device 20 against the target surface 5, after arranging the target object 2 such that the target surface 5 faces downward and before forming the brush coat 6a.

According to the present aspect, since the sanding device can be pressed against the target surface 5 from below, the sanding device can be prevented from coming into contact with a portion of the target surface 5 where no sanding is required due to the influence of the gravity. Accordingly, it is possible to perform sanding on only a portion of the target surface 5 requiring the sanding by pressing the sanding device against only the portion requiring the sanding.

(3) A seal application method according to a third aspect is the seal application method of (2), and may include steps S2, S4, S6, and S10 of cleaning the target surface 5 by inserting a cleaning device 10, which includes at an upper portion thereof a cleaning portion 11 with a solvent adhered thereto, into the narrow portion 4c and pressing the cleaning portion 11 upward and rubbing the cleaning portion 11 against the target surface 5, after arranging the target object 2 such that the target surface 5 faces downward and before or after step S3 of performing the sanding.

According to the present aspect, since the cleaning portion 11 can be pressed against the target surface 5 from below, the cleaning portion 11 can be prevented from coming into contact with a portion of the target surface 5 where no cleaning is required due to the influence of the gravity. Accordingly, it is possible to perform cleaning on only a portion of the target surface 5 requiring the cleaning by pressing the cleaning portion 11 against only the portion requiring the cleaning.

(4) A seal application method according to a fourth aspect is the seal application method of any one of (1) to (3), and may include steps S2, S4, S6, and S10 of cleaning the target surface 5 by inserting a cleaning device 10, which includes at an upper portion thereof a cleaning portion 11 with a solvent adhered thereto, into the narrow portion 4c and pressing the cleaning portion 11 upward and rubbing the cleaning portion 11 against the target surface 5, after arranging the target object 2 such that the target surface 5 faces downward and before or after step S5 of forming the brush coat 6a.

(5) A seal application method according to a fifth aspect is the seal application method of any one of (1) to (4), and may include, after forming the edge seal 6b, step S12 of inspecting adhesion of a seal 6 including the brush coat 6a and the edge seal 6b formed in the narrow portion 4c by inserting an inspection device 50, which includes a contact portion 55 protruding downward, into the narrow portion 4c and pressing and rubbing the contact portion 55 against the seal 6 from a direction intersecting an up-down direction Dv.

Accordingly, the adhesion of the seal 6 can be inspected. Thus, the accuracy of seal repairing can be improved.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A seal application method of applying a sealing material into a narrow portion serving as a hollow portion being formed inside a target object and communicating with outside, the seal application method comprising:
arranging the target object such that a target surface inside the narrow portion faces downward;
forming a brush coat by inserting into the narrow portion a brush coating device including at an upper portion thereof a brush portion with the sealing material adhered thereto, pressing the brush portion upward and rubbing the brush portion against the target surface, thereby applying the sealing material to the target surface;
after forming the brush coat, inverting the target object such that the target surface faces upward; and
after inverting the target object, forming an edge seal being thicker than the brush coat by inserting an edge sealing device into the narrow portion and causing the edge sealing device to apply the sealing material onto the brush coat from above.

2. The seal application method according to claim 1, further comprising sanding the target surface by inserting a sanding device into the narrow portion and pressing the sanding device upward and rubbing the sanding device against the target surface, after arranging the target object such that the target surface faces downward and before forming the brush coat.

3. The seal application method according to claim 2, further comprising cleaning the target surface by inserting a cleaning device, which includes at an upper portion thereof a cleaning portion with a solvent adhered thereto, into the narrow portion and pressing the cleaning portion upward and rubbing the cleaning portion against the target surface, after arranging the target object such that the target surface faces downward and before or after the sanding.

4. The seal application method according to claim 1, further comprising cleaning the target surface by inserting a cleaning device, which includes at an upper portion thereof a cleaning portion with a solvent adhered thereto, into the narrow portion and pressing the cleaning portion upward and rubbing the cleaning portion against the target surface, after arranging the target object such that the target surface faces downward and before or after forming the brush coat.

5. The seal application method according to claim 1, further comprising, after forming the edge seal, inspecting adhesion of a seal including the brush coat and the edge seal and being formed in the narrow portion by inserting an inspection device, which includes a contact portion protruding downward, into the narrow portion and pressing and rubbing the contact portion against the seal from a direction intersecting an up-down direction.
